(19) United States
(12) Patent Application Publication
(10) Pub. No.: US 2025/0371602 A1
(43) Pub. Date: Dec. 4, 2025

(54) ARTIFICIAL INTELLIGENCE DEVICE FOR LANGUAGE-BASED EFFICIENT AGENT UTILIZAITON FOR PLANNING (LEAP) AND METHOD THEREOF

(71) Applicant: LG ELECTRONICS INC., Seoul (KR)

(72) Inventors: Nikhil VERMA, Toronto (CA); Manasa BHARADWAJ, Toronto (CA)

(73) Assignee: LG ELECTRONICS INC., Seoul (KR)

(21) Appl. No.: 19/224,295

(22) Filed: May 30, 2025

Related U.S. Application Data
(60) Provisional application No. 63/654,007, filed on May 30, 2024.

(51) Int. Cl. G06Q 30/0601; G06F 16/334; G06F 16/335

(52) U.S. Cl. CPC G06Q 30/0631; G06F 16/334; G06F 16/335

(57) ABSTRACT

A method for controlling an artificial intelligence (AI) deice can include receiving a user query, searching a database to determine an initial subset of items based on the user query, determining, via a first large language model-based agent corresponding to an explore phase, a shortlisted set of items from among the initial subset of items, determining, via a second large language model-based agent corresponding to an exploit phase, a final selection from the shortlisted set based on a detailed analysis of attributes and options associated with items within the shortlisted set, and outputting the final selection.

### CROSS-REFERENCE TO RELATED APPLICATIONS

This non-provisional application claims priority under 35 U.S.C. § 119(e) to U.S. Provisional Application No. 63/654,007, filed on May 30, 2024, the entirety of which is hereby expressly incorporated by reference into the present application.

### BACKGROUND

### Field

The present disclosure relates to a device and method for an improved autonomous agent, in the field of artificial intelligence (AI). Particularly, the method can implement Language-based Efficient Agent utilization for Planning (LEAP) based a multi-stage framework which can provide substantial enhancements in agent processing efficiency and final selection accuracy by systematically combining an initial search with subsequent LLM-driven exploration and exploitation phases for task completion.

### Discussion of the Related Art

Artificial intelligence (AI) continues to transform various aspects of society and help users by powering advancements in various fields, particularly with regards to interactive applications, such as large language models (LLMs), chat-bots, and knowledge base question answering (KBQA) systems.

Further, the use of Large Language Models (LLMs) and agent-based systems is increasingly employed to assist users in complex decision-making and task-completion processes. These applications can span diverse areas, including online product recommendation and shopping, information retrieval from extensive databases, personalized planning services, and even robot control and management, aiming to provide users with relevant and timely assistance.

Existing systems attempting to leverage AI for such tasks often involve either direct interaction with a single, comprehensive LLM that processes a user query against a broad set of possibilities, or rely on simple database search mechanisms followed by rudimentary filtering. For instance, a user query for a product might be processed by an LLM attempting to parse details across an entire product catalog, or by a keyword search that returns a large, often noisy, set of initial results.

However, significant challenges arise when applying these existing AI approaches to tasks involving vast information spaces, such as navigating large e-commerce inventories or extensive knowledge bases. Directly employing a sophisticated LLM to evaluate every potential option from a massive dataset can lead to prohibitive computational costs, high latency, and inefficient resource utilization, which can significantly degrade the user experience.

For example, an LLM tasked with selecting the best apple phone for a user from a catalog of millions of products might expend considerable resources analyzing products that are only marginally relevant or clearly unsuitable (e.g., results regarding actual apples or fruit). Conversely, traditional database search techniques often lack the nuanced understanding of user intent or subtle product attributes that an LLM can provide, leading to a large volume of initial results that still require significant manual or further complex processing to refine.

Existing strategies to manage this complexity often involve either significant downscaling of the problem space, which may prematurely exclude optimal solutions, or the deployment of extremely large and resource-intensive LLMs, which are not always practical or economically viable, especially on end user devices or resource constrained environments. Some approaches may also attempt to fine-tune LLMs for specific domains, but this often requires substantial labeled datasets and retraining efforts, limiting their adaptability to new or rapidly changing environments. Consequently, these existing methods frequently suffer from a trade-off between the breadth of the initial search, the depth of intelligent analysis, and the overall efficiency of the system.

Thus, there exists a need for improved methods and systems that can more efficiently and effectively utilize the advanced understanding capabilities of LLMs for complex task completion in large information spaces. Such methods are needed to intelligently narrow down a vast field of initial possibilities to a manageable set for detailed evaluation, without incurring excessive computational expense or sacrificing the quality and relevance of the final outcome.

Furthermore, a need exists for a framework that can strategically integrate different processing stages, including efficient broad-phase searching and focused LLM-based analysis, in order to optimize resource utilization and enhance the scalability and accuracy of AI-driven agents in planning and selection tasks, thereby providing a more practical and powerful solution for assisting users.

Also, a need exists for a method that can achieve improved agent processing efficiency and final selection accuracy.

### SUMMARY OF THE DISCLOSURE

The present disclosure has been made in view of the above problems and it is an object of the present disclosure to provide a device and method that can provide improved agent processing efficiency and final selection accuracy, in the field of artificial intelligence (AI). Further, the method can provide an improved AI agent processing efficiency and final selection accuracy and action taking by systematically utilizing LLM-driven exploration and exploitation phases for task completion.

An object of the present disclosure is to provide an artificial intelligence (AI) device and method for Language-based Efficient Agent utilization for Planning (LEAP) that can enhance the efficiency and accuracy of AI-driven agents in complex task completion. According to an embodiment, the method can include a database search phase in which a large corpus of potential items or data points is broadly filtered based on a user query to yield a manageable subset. This subset can then be subjected to an explore phase where a first large language model (LLM) agent can intelligently analyze primary characteristics of the items within the subset to identify and shortlist a smaller group of highly promising candidates. Then, these shortlisted candidates can be passed to an exploit phase, in which a second LLM agent performs a more detailed and nuanced analysis of their specific attributes and options to determine and output a final, optimal selection, action or plan, thereby enabling a computationally efficient yet thorough decision-making process.

Another object of the present disclosure is to provide a method for controlling an artificial intelligence (AI) device that can include receiving, by a processor in the AI device, a user query, searching a database to determine an initial subset of items based on the user query, determining, via a first large language model-based agent corresponding to an explore phase, a shortlisted set of items from among the initial subset of items, determining, via a second large language model-based agent corresponding to an exploit phase, a final selection from the shortlisted set based on a detailed analysis of attributes and options associated with items within the shortlisted set, and outputting the final selection.

It is another object of the present disclosure to provide a method that further includes executing, by the processor, an action based on the final selection.

Yet another object of the present disclosure is to provide a method, in which the searching the database is performed without utilizing a large language model and employs at least one of a keyword-based search algorithm or a statistical relevance ranking algorithm.

An object of the present disclosure is to provide a method, in which the determining the shortlisted set of items by the first large language model-based agent is based on an analysis of high level information associated with each item in the initial subset, the high level information including at least one of item titles, item prices, and short item descriptions.

Another object of the present disclosure is to provide a method that further includes generating, via a reward model, relevance scores for items in at least a portion of the initial subset, the relevance scores being based on the user query and high-level details of the items in the at least a portion of the initial subset, and refining the initial subset based on the relevance scores to produce a refined subset of items, in which the first large language model-based agent determines the shortlisted set of items based on the refined subset of items.

An object of the present disclosure is to provide a method, in which the detailed analysis by the second large language model-based agent utilizes detailed information including one or more of full product descriptions, comprehensive attributes, and available configuration options for items in the shortlisted set of items.

Yet another object of the present disclosure is to provide a method, in which the first large language model-based agent and the second large language model-based agent are based on a same large language model.

An object of the present disclosure is to provide a method, in which the first large language model-based agent is guided by a first engineered prompt tailored to analyze high level information for the initial subset of items, and the second large language model-based agent is guided by a second engineered prompt tailored for detailed comparative analysis of attributes and options of the shortlisted set of items.

Another object of the present disclosure is to provide a method, in which at least one of the first large language model-based agent or the second large language model-based agent is based on an encoder-decoder architecture configured to employ self-attention mechanisms to weigh importance of different parts of an input sequence.

An object of the present disclosure is to provide a method the further includes executing, by the processor, an automated action on behalf of a user based on the final selection, the automated action including at least one of initiating a purchase transaction for a product corresponding to the final selection, booking a reservation, and controlling a robotic device based on the final selection.

Another object of the present disclosure is to provide an artificial intelligence (AI) device including a memory configured to store agent based prompt information, and a controller configured to receive a user query, search a database to determine an initial subset of items based on the user query, determine, via a first large language model-based agent corresponding to an explore phase, a shortlisted set of items from among the initial subset of items, determine, via a second large language model-based agent corresponding to an exploit phase, a final selection from the shortlisted set based on a detailed analysis of attributes and options associated with items within the shortlisted set, and output the final selection.

An object of the present disclosure is to provide a non-transitory computer readable medium storing computer-executable instructions that when executed by a processor, cause the processor to perform the operations of receiving a user query, searching a database to determine an initial subset of items based on the user query, determining, via a first large language model-based agent corresponding to an explore phase, a shortlisted set of items from among the initial subset of items, determining, via a second large language model-based agent corresponding to an exploit phase, a final selection from the shortlisted set based on a detailed analysis of attributes and options associated with items within the shortlisted set, and outputting the final selection.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 illustrates an example framework for autonomous agents according to an embodiment of the present disclosure.

FIG. 5 illustrates an example encoder-decoder based transformer architecture for a large language model according to an embodiment of the present disclosure.

FIG. 6 illustrates an example of an autonomous agent performing tasks on a computer according to an embodiment of the present disclosure.

FIG. 7 illustrates an example of an autonomous agent performing tasks in a web shopping environment according to an embodiment of the present disclosure.

FIG. 8 illustrates an example flow chart for a method of controlling an AI device to implement a Language-based Efficient Agent utilization for Planning (LEAP) method according to an embodiment of the present disclosure.

FIG. 9 illustrates an overview of a pipeline architecture for the LEAP framework according to an embodiment of the present disclosure.

FIG. 10 illustrates an overview of a pipeline architecture for the LEAP framework according to another embodiment of the present disclosure

FIG. 11 illustrates an example of an autonomous agent performing tasks in a web shopping environment according to an embodiment of the present disclosure.

FIG. 12 illustrates an example of navigation free autonomous agents performing tasks according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship. Also, the term “can” used herein includes all meanings and definitions of the term “may.”

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

For simplicity of explanation, a situation of an LLM based agent for online shopping is used an example, but embodiments are not limited thereto. For example, the LEAP model techniques disclosed herein can be applied to other types of situations and applications, such as information retrieval, travel planning, reservation assistance, customer support, route selection and planning, or any other type of application where a multi-stage filtering and selection process is beneficial. Self-driving refers to a technique of driving for oneself, and a self-driving vehicle refers to a vehicle that travels without an operation of a user or with a minimum operation of a user.

For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

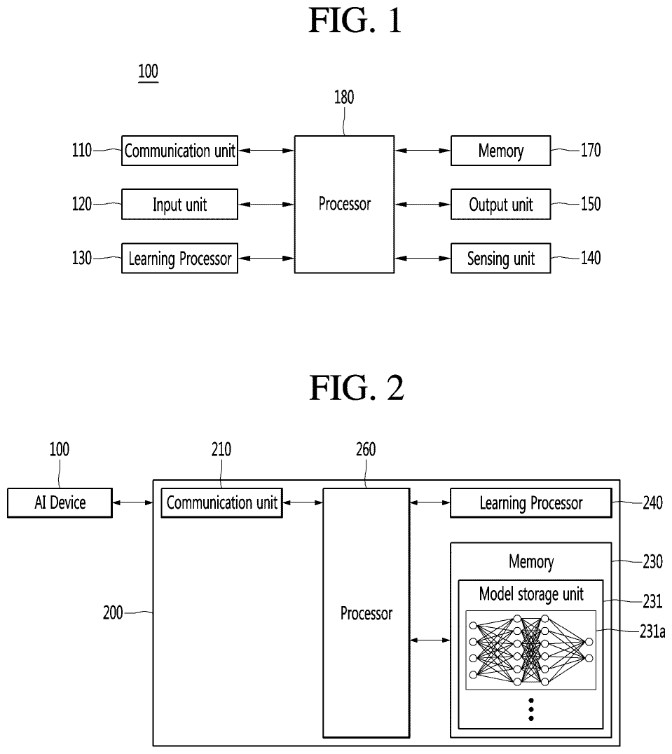

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

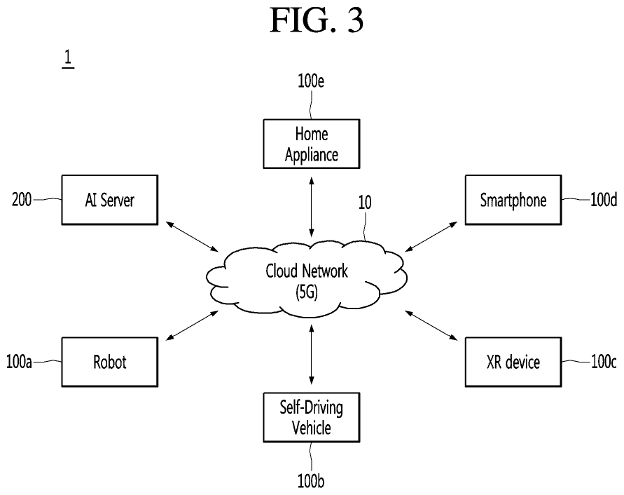

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire learning data for model learning and input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

For example, the learning processor 130 can perform AI processing together with the learning processor 240 of the AI server 200.

Also, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

Also, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a machine learning algorithm. The processor 180 can control the components of the AI device 100 to execute the determined operation. For example, the processor 180 can implement a Language-based Efficient Agent utilization for Planning (LEAP) AI model to generate output based on a plurality of modalities. Also, the generated output can be used by AI systems in various downstream related tasks other than text generate (e.g., object identification, control instructions to move a robot, control maneuvering for a self-driving vehicle, in game content generation, etc.).

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is used to perform the determined operation, the processor 180 can generate a control signal for controlling the external device and can transmit the generated control signal to the external device.

The processor 180 can acquire information from the user input and can determine an emotional state of the user and produce an answer to a query, carry out an action or movement, animate a displayed avatar or a recommend an item or action based on the determined emotional state.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. Also, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The AI model can be implemented in hardware, software, or a combination of hardware and software. If all or part of the learning models are implemented in software, one or more instructions that constitute the learning model can be stored in the memory 230.

The processor 260 can infer the result value for new input data by using the AI model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an interactive application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data. According to embodiments, the Language-based Efficient Agent utilization for Planning (LEAP) AI model can be fully implemented on an edge device (e.g., locally on devices 100a to 100e) or fully implemented AI server 200 in which an edge device collected the raw audio and video signals to provide to the AI server 200. According to another embodiment, parts of the LEAP AI model can be distributed across both of an edge device and the AI server 200.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100e.

In addition, the AI server 200 can learn the artificial neural network according to the machine learning algorithm instead of the AI devices 100a to 100e, and can directly store the learning model or transmit the AI model to the AI devices 100a to 100e.

Further, the AI server 200 can receive input data from the AI devices 100a to 100e, can infer the result value for the received input data by using the AI model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart washing machine or dryer, smart refrigerator or other display device, which can implement one or more of as a large language model (LLM), a chat-bot, a digital avatar assistant, an online shopping assistant or concierge, a question and answering system or a recommendation system, etc. The method can be in the form of an executable application or program.

The robot 100a, to which the AI technology is applied, can be implemented as an entertainment robot, a guide robot, a carrying robot, a cleaning robot, a wearable robot, a pet robot, an unmanned flying robot, a home robot, a care robot or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the AI model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

At this time, the robot 100a can perform the operation by generating the result by directly using the AI model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue, generate an output or an item to recommend. Also, the robot 100a can generate an answer in response to a user query and the robot 100a can have animated facial expressions. The answer can be in the form of natural language.

The map data can include object identification information about various objects arranged in the space in which the robot 100a moves. For example, the map data can include object identification information about fixed objects such as walls and doors and movable objects such as desks. The object identification information can include a name, a type, a distance, and a position.

In addition, the robot 100a can perform the operation or travel by controlling the driving unit based on the control/interaction of the user. Also, the robot 100a can acquire the intention information of the interaction due to the user's operation or speech utterance, and can determine the response based on the acquired intention information, and can perform the operation while providing an animated face.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b and the user's emotional state, or can control the function of the self-driving vehicle 100b through the interaction with the user. For example, when it is determined that the driver is in a drowsy state or an angry state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Alternatively, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle. Also, the robot 100a can provide information and services to the user via a digital avatar, which can be personally tailored to the user based on the user's emotional state and personal preferences.

According to an embodiment, the AI device 100 can provide Language-based Efficient Agent utilization for Planning (LEAP) for improved efficiency of agent actions and selection for carrying out complex tasks with accuracy and quality.

According to another embodiment, the AI device 100 can be integrated into an infotainment system of the self-driving vehicle 100b, which can recognize different users and their emotional states, and recommend content, provide personalized services or provide answers based on various input modalities, the content can include one or more of audio recordings, video, music, pod casts, etc., but embodiments are not limited thereto. Also, the AI device 100 can be integrated into an infotainment system of the manual or human-driving vehicle.

As discussed above, embodiments of the present disclosure relate to advancements in artificial intelligence (AI), particularly in the domain of AI agents. An artificial intelligence agent can be understood as a computational entity or system that perceives its environment through sensors or data inputs, processes this perceived information using internal logic or a model, and subsequently acts upon that environment through output mechanisms to achieve specific goals or tasks. The functionality of an AI agent is characterized by its ability to make decisions (e.g., either autonomously or semi-autonomously) linking its perceptions to actions in a rational or intelligent manner. Such agents can operate based on pre-defined rules and/or learned policies to optimize certain performance metrics over time.

For example, AI agents can be employed to perform a wide array of tasks across numerous fields. These tasks can include, but are not limited to, information retrieval and filtering from large datasets, providing personalized recommendations in e-commerce or content platforms, natural language understanding and generation for interactive dialogue systems, robotic control and navigation, scheduling and logistical planning, and complex problem-solving in domains such as finance or healthcare.

Further, the versatility of AI agents allows them to assist users by automating repetitive processes, offering decision support in complex scenarios, or managing interactions within digital or physical environments, particularly where intelligent adaptation or response to dynamic conditions is desired.

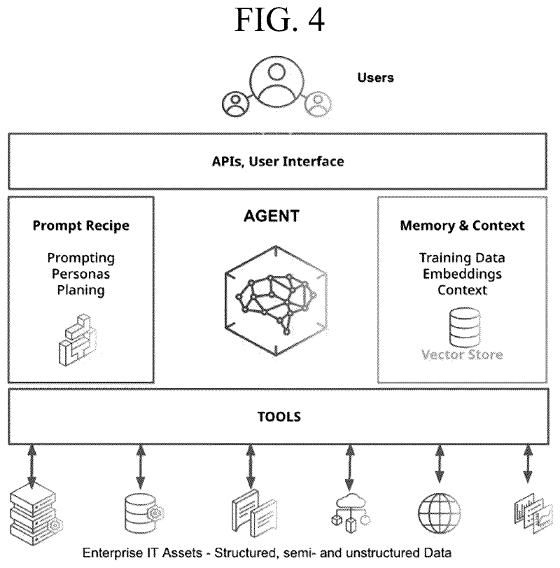

FIG. 4 illustrates an example framework for autonomous agents according to an embodiment of the present disclosure. Various types of AI agents can be distinguished based on their architecture, capabilities, and the sophistication of their decision-making processes. A brief overview includes simple reflex agents that act solely based on current percepts condition. Model-based reflex agents can maintain an internal state or model of the world to inform their actions. Goal-based agents can possess explicit goal information and select actions designed to achieve those goals. Utility-based agents can further refine this by selecting actions that maximize an expected utility or performance measure, allowing for trade-offs between conflicting goals or uncertain outcomes.

Furthermore, learning agents are capable of improving their performance over time by learning from experience and adapting their internal models or decision policies. According to embodiment, the AI model and method described herein can leverage or interact with principles from one or more of these agent types, particularly in the context of advanced learning agents incorporating large language models.

As discussed above, existing AI agent technology faces several issues. While AI agents offer considerable promise for assisting users in complex task completion, such as navigating online shopping environments or managing extensive information sets, their practical application is often encumbered by several significant challenges. These challenges can impair their efficiency, scalability and overall effectiveness, particularly when confronted with the scale and intricacy of real-world decision-making processes that involve numerous alternatives and substantial quantities of data.

For example, one type of challenge relates to scalability and computational cost, especially when AI agents are tasked with operating upon large datasets or a multitude of options. For instance, in online retail, an agent might need to consider millions of products, options and styles to satisfy a user's request. Employing a single, complex LLM pass to perform an exhaustive analysis across such a vast search space for an entire task can be computationally prohibitive. This approach often leads to unacceptable latency, high operational costs due to extensive computational resource consumption (e.g., processing time and memory), and may be infeasible for applications requiring near real-time responses or deployment in resource-constrained environments.

Further difficulties arise in maintaining context and precision throughout extended interactions or complex, multi-step decision-making processes. For example, as the number of potential choices and the volume of associated information grows, AI agents may struggle to consistently track user preferences, intricate dependencies, or nuanced details across all options.

Also, existing agents often exhibit limitations in their ability to effectively narrow down a large field of choices to a relevant, manageable subset without either incurring substantial computational overhead from deeply analyzing too many candidates or, conversely, prematurely discarding potentially optimal or highly relevant options through overly simplistic or coarse filtering mechanisms.

Thus, the limitations inherent in related-art AI agent methodologies for complex task completion frequently result in a suboptimal trade-off between processing efficiency, decision accuracy, and the comprehensiveness of the solution space considered. Accordingly, a need exists for improved systems and methods that can more intelligently and efficiently manage large-scale information and option spaces, enabling AI agents to deliver high-quality outcomes without the excessive computational burden or risk of information loss associated with prior approaches.

According to an embodiment, a device and method for Language-based Efficient Agent utilization for Planning (LEAP) to carry out complex tasks is provided. For example, the method can include a database search phase in which a large corpus of potential items or data points is broadly filtered based on a user query to yield a manageable subset. This subset can then be subjected to an explore phase in which a first large language model (LLM) agent can intelligently analyze primary characteristics of the items within the subset to identify and shortlist a smaller group of highly promising candidates. Subsequently, these shortlisted candidates can be passed to an exploit phase, in which a second LLM agent performs a more detailed and nuanced analysis of their specific attributes and options to determine and output a final, optimal selection, action, or plan, thereby enabling a computationally efficient yet thorough decision-making process.

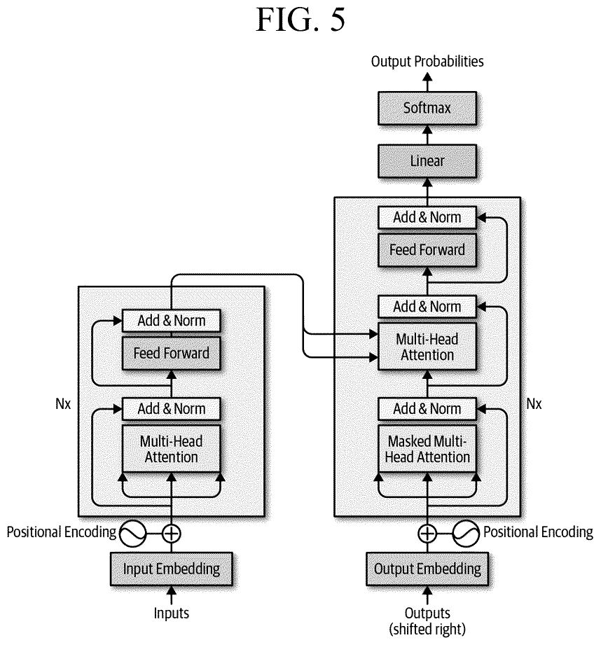

FIG. 5 illustrates an example encoder-decoder based transformer architecture for a large language model according to an embodiment of the present disclosure. For example, the LEAP method can leverage a large language model (LLM). According to an embodiment, the LLM can be based on an encoder-decoder architecture, which employs self-attention mechanisms.

Further, these attention mechanisms can allow the model to weigh the importance of different parts of an input sequence (e.g., words in a sentence or sentences in a document) when processing information, enabling the model to capture long-range dependencies and contextual relationships effectively, which is particularly relevant for understanding complex user queries or detailed product description.

According to an embodiment, the LLM can undergo a pre-training phase, in which the LLM is trained on a massive and diverse amount of text and code. During this unsupervised or self-supervised learning stage, the model can learn fundamental language patterns, grammatical structures, factual knowledge, and even reasoning capabilities (e.g., predicting masked words or the next sequence of text).

According to an embodiment, the LLM portion can be subject to a fine-tuning phase. Fine-tuning can involve further training the pre-trained model on smaller, more specialized datasets tailored to specific tasks (e.g., question answering, summarization, specific domain knowledge) or to align the model's behavior with desired characteristics, such as improved instruction following or safety protocols. According to embodiments, the LEAP AI model can advantageously utilize pre-trained LLMs, potentially without requiring extensive task-specific fine-tuning for its core agent functionalities. For example, according to an embodiment, the LEAP AI model can be LLM agnostic, but embodiments are not limited thereto.

For example, the LLM portion can operate by processing textual inputs (e.g., prompts) which can include questions, instructions, or other text intended to elicit a specific response. The LLM can leverages its learned knowledge to generate a corresponding textual output, such as an answer, a summary, or other contextually relevant content. Also, according to an embodiment, the LLM portion can be multi-modal to accept and operate on other types of input, such as images, video, etc.

According to embodiment, the Language-based Efficient Agent utilization for Planning (LEAP) AI model can provide an improved intelligent LLM-based agent process that can efficiently and accurately perform complex tasks. Embodiments of the LEAP framework are directed to a multi-stage method and device for agent utilization that can systematically process information and narrow down options, thereby optimizing the use of computational resources and agent capabilities. Further, this structured approach can address shortcomings in related art systems where a monolithic or less structured application of AI agents to large problem spaces may lead to inefficiencies or suboptimal outcomes.

For example, according to an embodiment, the LEAP AI model can provide a significantly improved approach for task completion, especially in scenarios involving extensive data and numerous potential choices, such as, but not limited to, online product selection and purchase, information retrieval, personalized planning, or even robot command and control.

Further, the LEAP method can enhance the ability of AI-driven systems to assist users by providing more relevant, accurate, and timely results or recommendations. This can be achieved by intelligently dividing the overall task into distinct phases, each tailored to a specific level of analysis and filtering, thereby improving upon existing methodologies that may lack such granular control and staged refinement. In this way, the method can provide a more robust and efficient process for arriving at a desired outcome or decision, such as carrying out a complex task to realize a user's goal.

According to an embodiment, the LEAP AI model and method can provide improved task completion through a structured workflow having several components or phases. For example, the multi-phase process can progressively refine a large set of initial possibilities down to a specific, actionable outcome.

According to an embodiment, various phases of the LEAP AI method can include an initial database search phase, an explore phase, and an exploit phase, in which each phase can contribute to the systematic and efficient processing of information for carrying out a task. The LEAP AI method can be applied to various types of situations and applications.

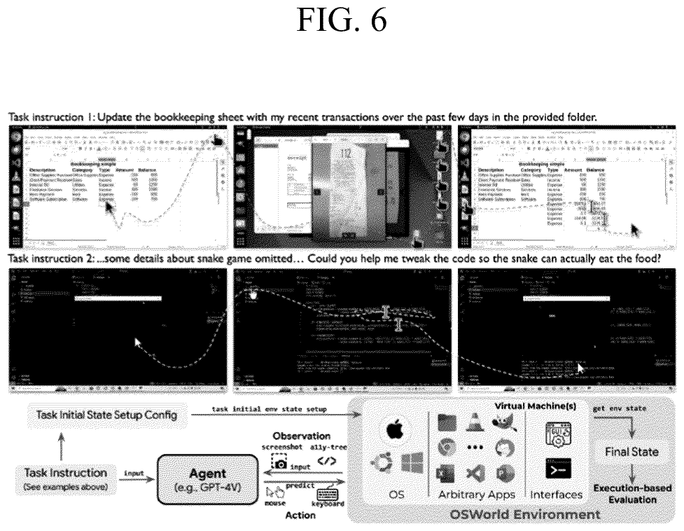

FIG. 6 illustrates an example of an autonomous agent performing tasks on a computer according to an embodiment of the present disclosure. For example, the LEAP AI model can be applied to a situation for carrying tasks on a user's personal computer (e.g., book keeping, budgeting, etc.).

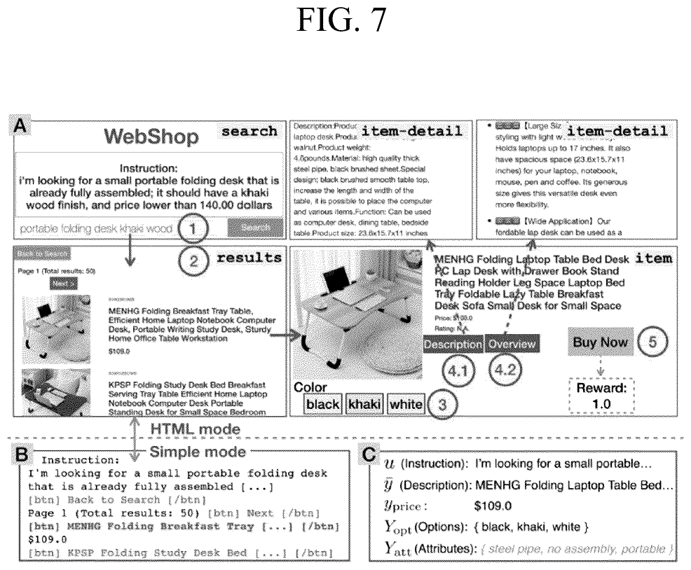

FIG. 7 illustrates an example of an autonomous agent performing tasks in a web shopping environment according to an embodiment of the present disclosure. For example, the LEAP AI model can be applied to a situation for purchasing an item online on behalf of a user.

For example, the initial database search phase can include performing a broad, initial filtering of a large corpus of items or data points (e.g., an extensive product catalog, a vast document repository) based on a user query or specified criteria. Also, this phase can be based on various search methodologies, such as keyword-based searching, indexed database queries, or other forms of information retrieval that do not necessitate the computational resources of a large language model (LLM). The output of the initial database search phase can be a subset of items that are broadly relevant to the user's input or query.

Further in this example, the resulting subset of items from the database search can be passed to an explore phase. The explore phase can leverage an LLM to further intelligently shortlist promising candidates from the subset generated by the database search. For example, a first LLM-based agent can analyze the items in the subset such as focusing on primary or readily discernible characteristics (e.g., titles, prices, key features, summary descriptions) in relation to the user query to identify a smaller, more manageable list of candidates that exhibit a higher likelihood of satisfying the user's need or intent.

Also, according to an embodiment, the explore phase can include a reward model component, which can help further enhance the list of candidates so that they are more aligned with the user's preferences or goals.

In addition, the reduced list of candidates produced by the explore phase can proceed to the exploit phase. According to an embodiment, the exploit phase can use a second LLM-based agent that conducts a detailed and nuanced analysis of these few selected candidates. For example, an in-depth examination can be performed for specific attributes, compare options comprehensively, consider subtle trade-offs, and ultimately determine and output a final most suitable item, plan, or piece of information as the final selection. This final selection can then be presented to the user or carried out on the user's behalf (e.g., a product purchase) or utilized for subsequent automated actions (e.g., controlling or moving a robot).

Also, the second LLM-based agent can be based on the same LLM as in the explore phase but operating under a different set of instructions or prompts, but embodiments are not limited there. For example, according to an embodiment, a different LLM model can be used for the exploit phase than the LLM model that was used in the explore phase, e.g., a distinct, potentially more specialized or powerful LLM, etc.

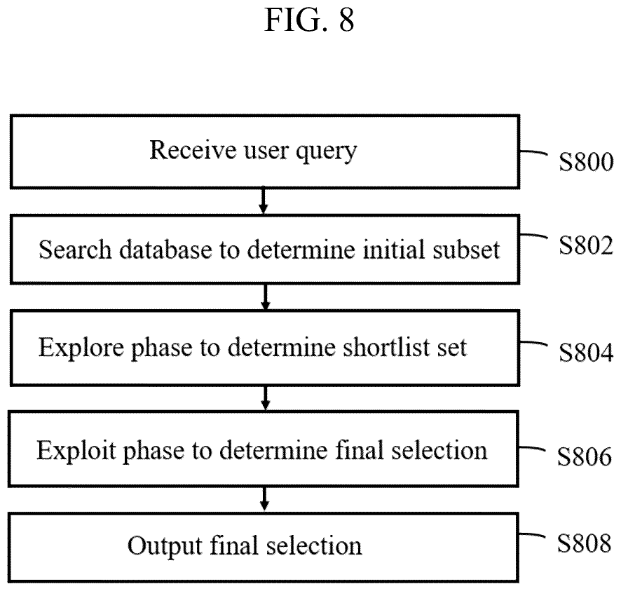

FIG. 8 shows an example flow chart of a method according to an embodiment of the present disclosure. For example, according to an embodiment, a method for controlling an AI device can include receiving, by a processor in the AI device, a user query (e.g., S800), searching a database to determine an initial subset of items based on the user query (e.g., S802), determining, via a first large language model-based agent corresponding to an explore phase, a shortlisted set of items from among the initial subset of items (e.g., S804), determining, via a second large language model-based agent corresponding to an exploit phase, a final selection from the shortlisted set based on a detailed analysis of attributes and options associated with items within the shortlisted set (e.g., S806), and outputting the final selection (e.g., S808).

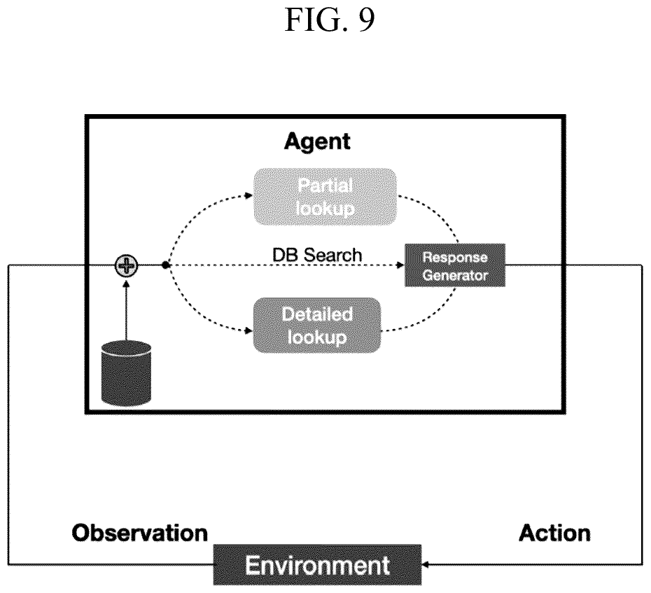

FIG. 9 illustrates an overview of the pipeline architecture of a LEAP AI model, according to an embodiment of the present disclosure. For example, according to an embodiment, the LEAP AI model can be implemented as a cohesive architecture of interconnected modules designed to implement the multi-phase workflow previously described.

For example, the AI device 100 implementing the LEAP AI model can be configured to receive one or more inputs, such as a user query, which can specify a user's need or intent, and access a database or a similar extensive corpus of items, products or data points. The inputs can initiate a process where data can flow sequentially or interactively through various processing modules, such as a database search module, an explore module, and an exploit module, which will be described in more detail below. Further, this processing can generate one or more outputs, such as a selected final product, a recommended action, or a curated piece of information, which represents the model's determination of the optimal outcome responsive to the user query and based upon the information within the database.

In more detail, the method can initiate a process with a database search module. The database search module can efficiently conduct an initial, broad-level filtering of a large search space. This initial filtering can substantially reduce the volume of data that needs to be processed by subsequent, more computationally intensive modules, such as those employing large language models (LLMs). According to an embodiment, this phase can operate without the direct involvement of an LLM to ensure high speed and efficiency when dealing with potentially vast datasets.

Further in this example, inputs to the database search module can include at least two main components, e.g., a user query and access to a database. The user query can be a textual input provided by a user, which can represent the user's needed task, question, or desired product/information. The database can represent a large corpus of items, such as an e-commerce website's inventory which might contain information on millions of individual products, including their descriptions, specifications, attributes and other associated metadata.

According to an embodiment, the processing within the database search module can be performed by a search mechanism configured for rapid retrieval from the database based on the user query. A characteristic of this stage is that the search mechanism may not be an LLM-based search, but embodiments are not limited thereto. Rather, the database search module can employ various information retrieval techniques.

For example, the search logic can be based on keyword matching, where terms from the user query are matched against terms in the product information, or exact matching schemes. In some embodiments, the database search module can leverage fast retrieval systems, such as those utilizing algorithms like Okapi BM25, Pyserini, or Elasticsearch. The user query can be taken as input and the model can perform a coarse search over the available items. Initial relevance can be determined based on the scoring methodology of the employed search algorithm (e.g., BM25 score), which can rank items based on their statistical relevance to the query terms.

The output of the database search module can an initial subset of potentially relevant items or products. This output can represent a significantly reduced set compared to the entirety of the database. For example, from an initial one million products, this phase might output a list of approximately one hundred top-ranked products deemed most relevant by the coarse search mechanism. This initial subset of items, along with potentially their relevance scores from this phase, can then be provided as input to the subsequent explore module for further, more nuanced processing.

Subsequent to the initial filtering performed by the database search module, the method can employ an explore module, see FIG. 9. The explore module can serve as the first stage within the LEAP framework where a Large Language Model (LLM) based agent is utilized, but embodiments are not limited thereto.

For example, the purpose and functionality of the explore module can be to perform an intelligent and semantic shortlisting of candidate items from the potentially large and somewhat coarsely filtered subset received from the database search module. This explore phase can bridge the gap between broad, keyword-based retrieval and deep, nuanced understanding by introducing LLM-driven analysis at an intermediate stage.

Further, the inputs to the explore module can include (i) the initial subset of potentially relevant items or products output by the database search module, and (ii) the original user query (e.g., user query), which can also be further supplemented with any refined aspects or contextual information derived from earlier processing or user interaction. This input provides the LLM agent within the explore module with both the candidate items and the user's articulated need or task.

The explore module can be based on a first LLM agent. While various types of LLMs characterized by robust natural language understanding (NLU) and generation (NLG) capabilities can be employed, this first LLM agent can be specifically configured for the task of efficient shortlisting. This configuration can include strategic prompt engineering, in which the LLM is provided with carefully designed instructions or prompts that guide its analysis.

As shown in Table I below, an example LEAP prompt template and example is provided based on a WebShop environment, but embodiments are not limited thereto.

TABLE I

| | |
|---|---|
| Prompt Template | Follow my instructions properly. |
| | You are real world agent who is shopping on the web. |
| | Select for me top-5 products with best matching options and features for |
| | “[Search_Instruction]” |
| | The details of the products available on the web are as below in json format. |
| | Please select only best matching product_ids. |
| | } |
| | [Search_Result_Products] |
| | } |
| | Only return 5 products ids from the json provided. |
| Prompt Example | Follow my instructions properly. |
| | You are a real world agent who is shopping on the web. |
| | Select for me top-5 products with best matching options and features for “black |
| | high quality cenglings womens cowl neck sweatshirt” |
| | The details of the products available on the web are as below in json format. |
| | Please select only best matching product_ids. |
| | { |
| | “B09MTX95LM”: “ViYW Women's Floral Print Shirts Button Cowl |
| | Neck Long Sleeve Tunic Tops Fashion Autumn Warm Blouses Casual Soft Tee; |
| | Price: $7.99 to $20.99”. |
| | “B09M472NR1”: “JJSUnS Women's Warm Long Sleeve Jackets With |
| | Hood Full Zip Up Fall Winter Tie Waist Coats Hoodie Windproof Outwear; |
| | Price: $28.99”, |
| | ... |
| | ... |
| | “B09H599BPH”: “Women Y2K Hooded Sweatshirt. Unisex Los Angeles |
| | California Hoodies Retro Long Sleeve Pullovers Distressed Tops; Price: |
| | $6.98 to $15.99”, |
| | “B07Y9K759Z”: “Barlver Women's Casual Long Sleeve Sweatshirts |
| | Fleece Cowl Neck Pullover Top Tunic Blouse Outwear: Price: $12.99”, |
| | ... |
| | ... |
| | “B09PL8RNS9”: “WENKOMG1 Men's Thin Henley Shirts Comfy |
| | Casual T-Shirt Long Sleeve V-Neck Tops Regular-Fit Oversize Blouse Business |
| | Solid Color Polo Shirts Spring/Summer Sweatshirt(Gray, 3X-Large); Price: |
| | $5.59”, |
| | “B09PLJ9RDX”: “WENKOMG1 Oversize T-Shirt for Men Long Sleeve |
| | Henley Shirts Casual Thin Tops Loose Solid Color Photo Polo Shirts V-Neck Business |
| | Blouse Comfy Spring/Summer Regular-Fit Sweatshirt(Blue, XX-Large); Price: |
| | $5.19” |
| | } |
| | Only return 5 product ids from the json provided. |

Another aspect of this explore phase is its focus on primary information associated with each candidate item. Such primary information can include, for example, product titles, short descriptions, prices, key features explicitly mentioned in summaries, and other data readily available without requiring a deep dive into detailed product pages or extensive linked information (e.g., such as drilling down into different attributes and options). This focus can help ensure that the explore module can process a relatively large number of candidates efficiently.

During processing, the LLM agent within the explore module can analyze the primary information of each item in the received subset in the context of the user query. This analysis can leverage the LLM's semantic understanding capabilities to perform a more sophisticated evaluation than simple keyword matching.

For example, where a database search might struggle to differentiate between homonyms or to grasp the true intent behind a query (e.g., matching “apple phone” to any product containing “apple” and “phone”), the LLM agent in the Explore Module can better discern semantic relevance, such as identifying an “iPhone” as the likely target for “apple phone” over other apple-branded products or actual apples or fruit. This can be conceptualized as an LLM-powered re-ranking or semantic filtering process, in which items are evaluated based on the semantic similarity of their primary information (e.g., title, short description) to the user query. This partial look-up capability can allow for a more nuanced initial assessment of relevance.

In addition, the LLM based agent in the explore module can also incorporate a form of look-ahead assessment or planning to further refine the shortlisting. In this context, the LLM agent can evaluate items (which can be considered potential “actions” for further consideration) by examining their available primary information (an “observation” associated with the item) against the task requirements defined by the user query.

For example, this look-ahead capability can allow the agent to intelligently anticipate or predict the potential of an item to satisfy the user's ultimate goal, even with the limited information available at this stage. By matching available item information with task requirements, the LLM agent can select a limited set of candidates perceived to have a high potential for relevance or utility which can reduce the exploration space for subsequent phases. For example, the criteria for shortlisting can involve selecting a top N number of candidates (e.g., the top 5 to 10 items) that receive the highest relevance scores or classifications from the LLM agent.

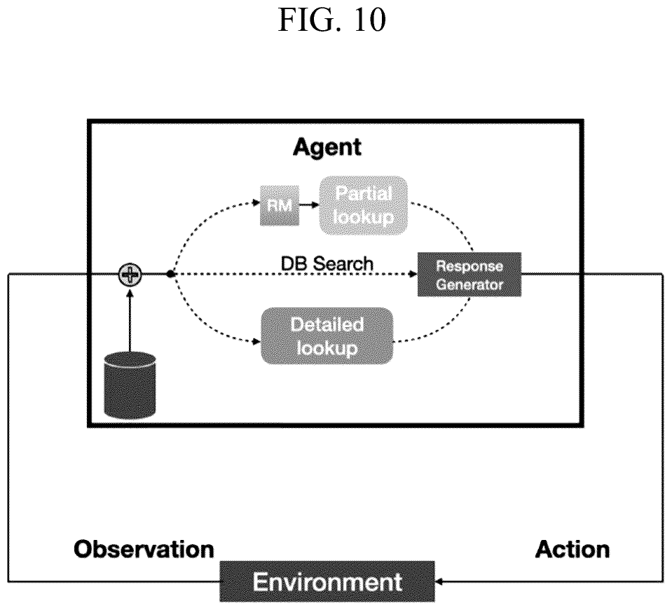

FIG. 10 illustrates an overview of a pipeline architecture for the LEAP framework according to another embodiment of the present disclosure. As shown in FIG. 10, according to an embodiment, the explore module can also interface with a reward model that can assess the quality of the candidates and/or provide feedback to adapt the LLM agent's parameters or prompting strategies over time.

For example, the reward model can be a specialized model trained to predict or quantify the likely human preference for a given output (e.g., a piece of text, a product selection) in response to a specific input or prompt (e.g., a user query). The reward model can be trained on datasets including examples of human preferences, such as comparisons between different responses to the same prompt (e.g., prompt-chosen-rejected trios).

In addition, through this training, the reward model can learn to assign a scalar score or a probability distribution indicative of the degree to which an item or response is likely to align with human preferences or satisfy the underlying intent of a given query (e.g., a score between 0 and 1). The output of the explore module can be a first reduced set of candidate items or products. This set is significantly smaller and more semantically refined than the result received from the database search module.

Within the architecture of the LEAP framework, the reward model can be strategically incorporated, for example, between the database search module and the explore module. In this configuration, the inputs to the reward model can include (i) the user query, serving as the contextual prompt, and (ii) the initial subset of potentially relevant items or products that are output by the database search module. Each item in this subset, along with its associated primary information (e.g., title, brief description), can be considered a potential “completion” or response to the user query.

The functionality of the reward model in this position within the LEAP workflow can be to further refine and prioritize the subset of items received from the database search module. For each item in the subset, the reward model can generate a preference score (e.g., a score between 0 and 1, such as 0.8). This score can be determined by the reward model based on its learned model of human preferences as applied to the specific user query and the available information for that item.

For example, according to an embodiment, the reward model can be trained on e-commerce preference data to assess how likely a user issuing a particular query is to prefer one product over another from the initial search results, based on features like product category, brand, or alignment of descriptive terms with nuanced aspects of the query that a purely keyword-based search might miss. The output of this reward model stage can the same subset of items augmented with these preference scores, or, alternatively, the subset can be re-ranked according to these scores.

For example, the incorporation of the reward model can provide several benefits to the subsequent explore module and the overall LEAP architecture. By providing an intermediate layer of preference-based scoring or re-ranking, the reward model can help focus the analytical efforts of the LLM agent in the explore module on the most promising candidates.

For instance, the explore module might be configured to process only the top N items as ranked by the reward model, thereby reducing its computational load. Alternatively, the preference scores from the reward model can be used as an additional input feature or heuristic for the explore module's LLM agent to guide its own shortlisting process. This pre-emptive refinement by a specialized reward model can enhance the overall efficiency, speed, and potentially the accuracy of the LEAP framework in identifying the optimal final selection that aligns with user preferences.

For example, according to an embodiment, the reward model can perform an additional shortlisting step on items received from the database search module, before these items are processed by the LLM based agent of the explore module. This reward model can takes as input the user query and high-level details (such as price and title) for each product provided by the database search. For each such product, the reward model can then generate a numerical relevance score within a defined range (e.g., 0 to 1), indicating the product's assessed relevance to the user query. Following the scoring, these products are commonly sorted by their scores, and a predetermined top fraction (e.g., the highest-scoring half) can selected, thereby creating a further reduced intermediate list of candidate products.

Further, this intermediate list of candidate products scored and filtered by the reward model can be passed as input to the explore module. An advantage of incorporating this reward model stage can be the substantial reduction in the number of items requiring evaluation by the more computationally intensive LLM agent of the explore module. For example, by pre-qualifying and narrowing the set of candidates based on key features, the reward model can enhance the overall computational efficiency and processing speed of the LEAP framework. This can allow the explore module to focus its semantic analysis on a smaller, more relevant set of items.

As shown in Table II below, an example reward model input text template and example is provided, but embodiments are not limited thereto.

TABLE II

| | |
|---|---|
| Input template | { |
| | { |
| | “role”: “user”, |
| | “content”: goal_instruction |
| | }, |
| | { |
| | “role”: “assistant”, |
| | “content”: product |
| | }, |
| | } |
| Input example | { |
| | { |
| | “role”: “user”, |
| | “content”: I need gluten free |
| | vegetarian smoked peppered |
| | bacon-4 ounce (pack of 2), and |
| | price lower than 50.00 dollars. |
| | }, |
| | { |
| | “role”: “assistant”, |
| | “content”: $64.99- |
| | OMEALS Pasta Fagioli Six |
| | Vegetarian MRE Sustainable |
| | Premium Outdoor Fully Cooked |
| | Meals w/Heater-Extended |
| | Shelf Life-No Refrigeration- |
| | Perfect for Travelers. Emergency |
| | Supplies-USA 6 Pack |
| | }, |
| | } |

Further in this example regarding the interaction between the database search module and the explore module, an input of approximately one hundred items might be reduced to about five to ten highly promising candidates. This output, which can include the shortlisted items themselves along with any associated relevance scores, semantic interpretations, or pertinent information about why these items were selected (e.g., representing “potential actions and consequences” in an abstract sense), can then passed as input to the subsequent exploit module for detailed, in-depth analysis.

According to an example, the initial database search phase can search a database of one million products and reduce it to a subset of about 100 top potential picks, and then the explore phase can reduce this subset even further to produce the 5 or 10 candidates, which can be passed to the exploit module.

With reference again to FIG. 9, following the shortlisting and semantic refinement performed by the explore module, the LEAP method can proceed to its final primary processing stage, the exploit module, which can include a response generator. The purpose and functionality of the exploit module can be to conduct a comprehensive and detailed analysis of the highly promising, small set of candidate items (e.g., the top 5 products) received from the explore module.

Based on this in-depth evaluation, the exploit module can make the final selection of a single item, product, service, or plan that is determined to best satisfy the original user query and objectives.

For example, the inputs to the exploit module can include (i) the reduced and refined set of candidate items outputted by the explore module, and (ii) the user query. Also, for the few candidates under consideration in this phase, the exploit module can leverage substantially more detailed information than was utilized in the preceding explore module. This detailed information, can include not only primary data like price and title, but also comprehensive attributes, available options (e.g., color, size), full product descriptions, specifications, and other pertinent metadata associated with each candidate item.

The exploit module can employ a second Large Language Model (LLM) based agent, or an LLM specifically configured for the exploitation task. Accordingly to an embodiment, this LLM agent can be the same model as used in the explore module but guided by different operational parameters or prompt engineering strategies, or it can be a distinct LLM, e.g., potentially a larger or more specialized model, optimized for nuanced comparative analysis and definitive decision-making.

According to an embodiment, prompt engineering for this phase can specifically designed to instruct the LLM agent to perform a detailed examination of each candidate. Such prompts can direct the LLM to focus on specific product attributes, consider all available options, perform deeper comparisons between the candidates, and evaluate them rigorously against the explicit and implicit requirements of the user query.

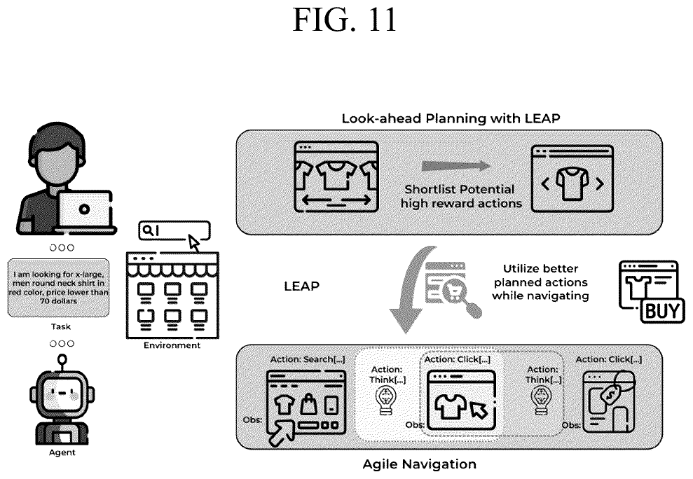

FIG. 11 illustrates an example of an autonomous agent performing tasks in a web shopping environment according to an embodiment of the present disclosure.

As shown in Table III below, an example product page LEAP prompt template and example is provided based on a WebShop environment, but embodiments are not limited thereto.

TABLE III

| | |
|---|---|
| Prompt Template | Follow my instructions properly. |
| | You are a real world agent who is shopping on the web. |
| | Select for me ONE best product with matching options and features for |
| | “[Human_Instruction]” |
| | The details of the products available on the web are as below in json format. |
| | Please select only best matching product_ids. |
| | { |
| | [Partial_lookup_response_Products] |
| | } |
| | Only return ONE of the selected best product's id. |
| Prompt Example | Follow my instructions properly. |
| | You are a real world agent who is shopping on the web. |
| | Select for me ONE best product with matching options and features for “black |
| | high quality cenglings womens cowl neck sweatshirt”. |
| | The details of the products available on the web are as below in json format. |
| | Please select only best matching product_ids. |
| | { |
| | ... |
| | “B09M472NR1”: { |
| | “title_price”: “JJSUnS Women's Warm Long Sleeve Jackets With |
| | Hood Full Zip Up Fall Winter Tie Waist Coats Hoodie Windproof Outwear: |
| | Price: $28.99”. |
| | “options”; “size [small][medium][large][x-large]”, |
| | “attributes”: “long sleeve; improved zipper; light weight; jacket |
| | women; faux fur; pullover hoodie; loose fit; daily wear; slim fit; fashion; |
| | women's fashion hoodies & sweatshirts”, |
| | “description”: “Special V neck/High Neck/Crew Neck/U- |
| | Neck/Open Neck/Boat Neck/Scoop Neck/Leopard Print/Turtle Neck/Half Zip/- |
| | Cowl Neck Design” }, |
| | ... |
| | } |
| | Only return ONE of selected best product's id. |

In addition, the LLM agent within the exploit module can perform an in-depth analysis of each shortlisted candidate. This can involve a detailed look-up where the agent thoroughly reviews and matches the user query against all available metadata for each candidate, including their detailed descriptions, attributes and options.

For example, in embodiments where the LEAP method operates within dynamic environments, such as interacting with e-commerce websites or other online platforms, the acquisition of detailed information for the exploit module's in-depth analysis can involve active data gathering by an automated agent.

According to an embodiment, this automated agent can be an integral part of the LLM agent within the exploit module or a distinct sub-module or tool directed thereby, which is configured to navigate to and interact with web pages associated with the shortlisted candidate items received from the explore module. This capability can allow the exploit module to access comprehensive and up-to-date details that may not be present in an initial database or summary information.

The automated agent's web page navigation and interaction capabilities can include several functionalities. For instance, upon receiving a shortlisted item (e.g., identified by a URL or product ID), the agent can be configured to retrieve the corresponding product detail page. Once on such a page, the agent can programmatically identify and interact with various web page elements to unveil or specify product variations and collect associated data. This process can involve selecting options from drop-down menus (e.g., for attributes such as size, color, material, or configuration), clicking on radio buttons or checkboxes representing different choices, or even inputting data into specific fields if required to customize a product view. The agent can parse the Document Object Model (DOM) of the web page or utilize other web scraping and browser automation techniques to locate these interactive elements and extract the resulting information.

For example, as the automated agent interacts with these web page elements for each shortlisted item, the agent can systematically extract the pertinent detailed information. This can include, but is not limited to, variant-specific pricing, availability status for selected options, detailed specifications, customer reviews associated with particular configurations, images, and any other attributes or descriptive text that become visible or accessible as a result of these interactions.

This gathered information can then compiled, structured, and associated with the respective candidate item. This rich, interactively-obtained dataset can form the comprehensive basis upon which the LLM agent in the exploit module performs its detailed comparative analysis and makes its final selection, as previously described.

According to another embodiment, the acquisition of detailed information for the exploit module can be accomplished without requiring explicit navigation of web page interfaces by an automated agent. In such configurations, the environment can be designed such that all necessary information for the detailed look-up or analysis phase can be retrieved directly from a backend database, structured data feeds, or similar directly queryable data sources. While conceptual navigation might occur, such as selecting an item from a list generated by the explore module to access its full record, the system can obviate the need for an agent to interact with and parse dynamic web page elements like drop-down menus or selectable options on a live website. The underlying data architecture in these embodiments can permit direct fetching of comprehensive item attributes and details once an item has been shortlisted.

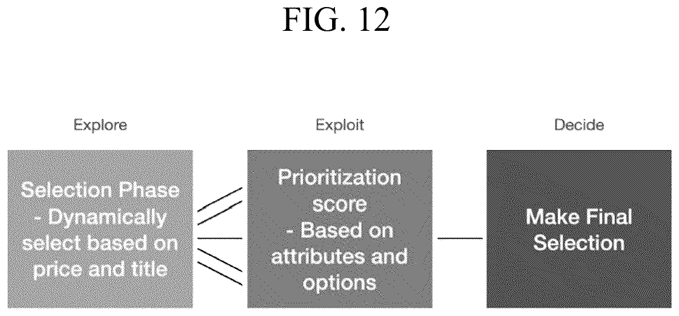

FIG. 12 illustrates an example of navigation free autonomous agents performing tasks according to an embodiment of the present disclosure. For example, in environments where such direct backend access to detailed information is available, thereby eliminating the need for explicit UI navigation for data gathering, the LEAP framework's operational flow can be represented in a more streamlined or distilled manner, for example, as shown in FIG. 12.

For example, an agent employing the framework can still effectively complete its task by performing at least one round of a partial look-up to initially vet candidates based on primary information, followed by at least one round of a detailed look-up utilizing the directly accessed comprehensive information. This sequence can ensure that sufficient data is analyzed for informed, final decision-making by the agent.

Further, the exploit module can synthesize this comprehensive information for each product and perform comparative evaluations across the candidates. For instance, the exploit module can weigh different features, assess compatibility with user-stated constraints, and/or infer the overall suitability of each option to achieve the user's task or satisfy user preferences.

Based on this comprehensive analysis and comparison, the LLM agent in the exploit module can determine a final selection. The criteria for this final selection can be to identify the single best match, the item with the highest predicted utility, or the most relevant product that aligns with the user's query and inferred intent. This process can involve a final internal re-ranking of the few candidates, with the top-ranked item being chosen. The output of the exploit module can be the selected final item or product (e.g., represented by its unique identifier or product ID) which can then be designated for purchase, recommendation to the user, or initiation of a subsequent action.

According to an embodiment, the LEAP method can include purchasing and ordering the final selected item, and having it shipped to a predetermined address or destination associated with the user.

Various experiments were carried out against related art models to evaluate the results.

As shown in Table IV below, the LEAP AI model according to embodiments outperforms other related-art methods.

TABLE IV

| | |
|---|---|
| Task Score | Success Rate |

WebShop environment

| | | |
|---|---|---|
| Rule-based | 44.8 | 9.2 |

Learning-based baseline models_{(Yao et al., 2022a)}

| | | |
|---|---|---|
| IL | 60.4 | 28.0 |
| IL + RL | 62.4 | 28.7 |

Open-source LLM - Gemma-2-9B

| | | |
|---|---|---|
| ReAct | 13.1 | 4.0 |
| LEAP | 63.1 | 27.4 |

API-based LLM - Gemini

| | | |
|---|---|---|
| ReAct | 35.4 | 21.8 |
| LEAP | 70.4 | 42.8 |
| Human Expert | 82.1 | 59.6 |

As shown above, drawing upon the experimental evaluations conducted in the WebShop environment, a synthetic online shopping platform containing a large database of items and user instructions, the efficacy of the disclosed framework for autonomous agents performing planning and reasoning was empirically demonstrated. Using Task Score and Success Rate metrics to measure performance, it was shown that the LEAP method, employing look-ahead planning, significantly improved performance compared to the ReAct strategy.

For example, with the Gemma-2-9B agent, LEAP achieved a Task Score of 63.1% and a Success Rate of 27.4%, markedly surpassing ReAct's scores of 13.1% and 4.0% respectively. Similar performance trends were observed when evaluating with the Gemini model. These results underscore that the proposed framework, through phases of explore (e.g., partial look-up) and exploit (e.g., detailed look-up) effectively enhances the planning and reasoning capabilities of LLM-based autonomous agents in complex task-oriented domains.

According to an embodiment, the AI device 100 can be configured to achieve improved agent processing efficiency and final selection accuracy. The AI device 100 can be used in various types of different situations.

According to one or more embodiments of the present disclosure, the AI device 100 can solve one or more technological problems in the existing technology, such as strategically integrating different processing stages, including efficient broad-phase searching and focused LLM-based analysis, in order to optimize resource utilization and enhance the scalability and accuracy of AI-driven agents in planning and selection tasks, thereby providing a more practical and powerful solution for assisting users.

For example, embodiments of the LEAP method can provide numerous advantages over conventional systems for AI-driven task completion, particularly those relying on monolithic or less structured approaches. The LEAP method can provide improved efficiency and reduced computational cost, especially when compared to systems that might employ a single, Large Language Model (LLM) to process an entire vast search space from the outset. By segmenting the task into distinct phases, beginning with a computationally less intensive database search and strategically deferring LLM engagement to progressively smaller and more relevant subsets of data, the LEAP framework can optimize resource utilization. This architectural design can also contribute to enhanced scalability, which can be highly effective for tasks involving extremely large search spaces, such as comprehensive e-commerce product catalogs or extensive document repositories.

Further, the LEAP method can offer practical applicability by its ability to leverage existing pre-trained LLMs for its agent functionalities, potentially obviating the need for extensive, resource-intensive new model training or task-specific fine-tuning for each deployment.

In addition, the structured, multi-stage process in the LEAP framework can lead to better task completion accuracy and higher quality final selections. The systematic and more effective narrowing of options (e.g., form broad filtering in the database search phase, to semantic shortlisting in the explore phase, and culminating in meticulous analysis in the exploit phase) can help ensure that the decision-making is both thorough and focused on the most pertinent candidates. This methodology can facilitate better final selections that are more closely aligned with user intent and requirements.

Also, an additional advantage is the flexibility in configuring different LLMs or specialized AI agents for different stages of the workflow. For example, a computationally leaner LLM can be employed for the initial semantic filtering in the explore phase, while a more powerful or domain-specific LLM can be reserved for the critical in-depth analysis in the exploit phase. This adaptability can allow for a tailored optimization of performance and resource allocation across the various components of the system, further contributing to its overall effectiveness.

Also, according to an embodiment, the AI device 100 configured with the LEAP AI model can be used in a mobile terminal, a smart TV, a home appliance, a robot, an infotainment system in a vehicle, etc.

For example, the AI device can be applied in a wide range of interactive applications including a digital assistant, a question and answering system, and a home robot. For example, according to an embodiment, the home robot can determine the user's intent and based on this information, the robot can perform a more relevant helping or caring action, or provide a better answer or information that more accurately addresses the user's needs.

In addition, the LEAP framework's structured, multi-stage methodology for efficient information processing and decision-making allows for its application in diverse real-world contexts. In e-commerce and online shopping, for example, the method can enhance product recommendation and selection from vast online catalogs by systematically filtering numerous options and then performing detailed analysis on the most promising candidates using its phased approach. Similarly, in travel planning, the LEAP framework can assist users in selecting optimal flights, hotels, or itineraries by efficiently managing and comparing numerous choices based on user preferences through its structured evaluation process.

Furthermore, the LEAP method can be beneficial in various information-centric domains. For information retrieval, the framework can be adapted to efficiently locate specific documents or data within large corpora by employing its phased approach for initial broad searching followed by more targeted, LLM-driven analysis.

Also, in customer support applications, the LEAP method can effectively guide users to the most relevant help articles or solutions from extensive knowledge bases, thereby improving support efficiency.

More broadly, the principles of the LEAP method extend to many other potential applications where any multi-stage filtering, analysis, and selection process is advantageous for achieving accurate and efficient task completion or decision support in complex environments with numerous options.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) deice, the method comprising:
receiving, by a processor in the AI device, a user query;
searching, by the processor, a database to determine an initial subset of items based on the user query;
determining, via a first large language model-based agent corresponding to an explore phase, a shortlisted set of items from among the initial subset of items;
determining, via a second large language model-based agent corresponding to an exploit phase, a final selection from the shortlisted set based on a detailed analysis of attributes and options associated with items within the shortlisted set; and
outputting the final selection.

2. The method of claim 1, further comprising:
executing, by the processor, an action based on the final selection.

3. The method of claim 1, wherein the searching the database is performed without utilizing a large language model and employs at least one of a keyword-based search algorithm or a statistical relevance ranking algorithm.

4. The method of claim 1, wherein the determining the shortlisted set of items by the first large language model-based agent is based on an analysis of high level information associated with each item in the initial subset, the high level information including at least one of item titles, item prices, and short item descriptions.

5. The method of claim 1, further comprising,
generating, via a reward model, relevance scores for items in at least a portion of the initial subset, the relevance scores being based on the user query and high-level details of the items in the at least a portion of the initial subset; and
refining the initial subset based on the relevance scores to produce a refined subset of items,
wherein the first large language model-based agent determines the shortlisted set of items based on the refined subset of items.

6. The method of claim 1, wherein the detailed analysis by the second large language model-based agent utilizes detailed information including one or more of full product descriptions, comprehensive attributes, and available configuration options for items in the shortlisted set of items.

7. The method of claim 1, wherein the first large language model-based agent and the second large language model-based agent are based on a same large language model.

8. The method of claim 1, wherein the first large language model-based agent is guided by a first engineered prompt tailored to analyze high level information for the initial subset of items, and
wherein the second large language model-based agent is guided by a second engineered prompt tailored for detailed comparative analysis of attributes and options of the shortlisted set of items.

9. The method of claim 1, wherein at least one of the first large language model-based agent or the second large language model-based agent is based on an encoder-decoder architecture configured to employ self-attention mechanisms to weigh importance of different parts of an input sequence.

10. The method of claim 1, further comprising:
executing, by the processor, an automated action on behalf of a user based on the final selection, the automated action including at least one of initiating a purchase transaction for a product corresponding to the final selection, booking a reservation, and controlling a robotic device based on the final selection.

11. An artificial intelligence (AI) device, comprising:
a memory configured to store agent based prompt information; and
a controller configured to:
receive a user query,
search a database to determine an initial subset of items based on the user query,
determine, via a first large language model-based agent corresponding to an explore phase, a shortlisted set of items from among the initial subset of items,
determine, via a second large language model-based agent corresponding to an exploit phase, a final selection from the shortlisted set based on a detailed analysis of attributes and options associated with items within the shortlisted set, and
output the final selection.

12. The AI device of claim 11, wherein the controller is further configured to:
execute an automated action on behalf of a user based on the final selection, the automated action including at least one of initiating a purchase transaction for a product corresponding to the final selection, booking a reservation, and controlling a robotic device based on the final selection.

13. The AI device of claim 11, wherein searching of the database based on the user query is performed without utilizing a large language model and employs at least one of a keyword-based search algorithm or a statistical relevance ranking algorithm.

14. The AI device of claim 11, wherein the shortlisted set of items is determined by the first large language model-based agent based on an analysis of high level information associated with each item in the initial subset, the high level information including at least one of item titles, item prices, and short item descriptions.

15. The AI device of claim 11, wherein the controller is further configured to:
generate, via a reward model, relevance scores for items in at least a portion of the initial subset, the relevance scores being based on the user query and high-level details of the items in the at least a portion of the initial subset, and
refine the initial subset based on the relevance scores to produce a refined subset of items,
wherein the first large language model-based agent determines the shortlisted set of items based on the refined subset of items.

16. The AI device of claim 11, wherein detailed analysis performed by the second large language model-based agent utilizes detailed information including one or more of full product descriptions, comprehensive attributes, and available configuration options for items in the shortlisted set of items.

17. The AI device of claim 11, wherein the first large language model-based agent and the second large language model-based agent are based on a same large language model.

18. The AI device of claim 11, wherein the first large language model-based agent is guided by a first engineered prompt tailored to analyze high level information for the initial subset of items, and
wherein the second large language model-based agent is guided by a second engineered prompt tailored for detailed comparative analysis of attributes and options of the shortlisted set of items.

19. The AI device of claim 11, wherein at least one of the first large language model-based agent or the second large language model-based agent is based on an encoder-decoder architecture configured to employ self-attention mechanisms to weigh importance of different parts of an input sequence.

20. A non-transitory computer readable medium storing computer-executable instructions that when executed by a processor, cause the processor to perform the operations of:
receiving a user query;
searching a database to determine an initial subset of items based on the user query;
determining, via a first large language model-based agent corresponding to an explore phase, a shortlisted set of items from among the initial subset of items;
determining, via a second large language model-based agent corresponding to an exploit phase, a final selection from the shortlisted set based on a detailed analysis of attributes and options associated with items within the shortlisted set; and
outputting the final selection.
